(19) United States
(12) Patent Application Publication
(10) Pub. No.: US 2024/0107949 A1
(43) Pub. Date: Apr. 4, 2024

(54) TORQUE LIMITER APPARATUS FOR A MOWER HAVING A ROTATING BLADE

(71) Applicant: MTD PRODUCTS, INC., Valley City, OH (US)

(72) Inventors: Timothy Clapp, Queen Creek, AZ (US); Nathaniel Byrne, Columbia Station, OH (US)

(21) Appl. No.: 18/375,047

(22) Filed: Sep. 29, 2023

Related U.S. Application Data
(60) Provisional application No. 63/411,659, filed on Sep. 30, 2022.

(51) Int. Cl. A01D 69/08; A01D 34/66; A01D 34/78

(52) U.S. Cl. CPC A01D 69/08; A01D 34/66; A01D 34/78; A01D 2101/00

(57) ABSTRACT

A torque limiter assembly and/or damage mitigation assembly that can limit torque and other forces from being applied to a motor or motor assembly of a lawn maintenance device such as a mower. For example, sudden blade-stop events or other events that might damage the motor can instead be absorbed or dispersed by the torque limiter assembly via use of a friction material. The torque limiter assembly can have a shaft and bearings that are independent of the motor shaft and motor bearings. The friction material can serve as a mechanical linkage between the two independent shafts operating to limit torque exchanges between the two shafts that exceed a defined magnitude. In the event that wear or damage is sustained, such will tend to be limited to the torque limiter assembly, which can be repaired or replaced in a more cost effective or simplified manner than the motor assembly.

### CROSS-REFERENCE TO RELATED APPLICATION

This application claims the benefit of U.S. Provisional Application No. 63/411,659, filed Sep. 30, 2022.

### FIELD OF DISCLOSURE

The disclosed subject matter generally pertains to apparatuses that can limit torque for a mower having a rotating blade, and more specifically to torque limiter apparatuses that mitigate or prevent torque spikes and other stresses, such as those due to a sudden stop of the rotating blade, from damaging an associated motor or surrounding components.

### BACKGROUND

Manufacturers of power equipment for outdoor maintenance applications (e.g., mowers) offer many types of machines for general maintenance and mowing applications. Generally, these machines can have a variety of forms depending on application, from general urban or suburban lawn maintenance, rural farm and field maintenance, to specialty applications. Even specialty applications can vary significantly. For example, mowing machines suitable for sporting events requiring moderately precise turf, such as soccer fields or baseball outfields may not be suitable for events requiring very high-precision surfaces such as golf course greens, tennis courts and the like.

Power equipment can vary in terms of available operator positions. Some power equipment have a standing and/or walking operator positions adjacent to the power equipment (e.g., push mowers or tillers, etc.), while other power equipment have a riding operator positions on the power equipment, such as a seated operating position (e.g., riding mowers, etc.) or a standing operator position (e.g., standing mowers, etc.).

Modern maintenance machines also offer multiple options for power source. The various advantages associated with electric motor engines, gasoline engines, natural gas engines, diesel engines and so forth also impact the mechanical design and engineering that go into these different maintenance devices. Meeting the various challenges associated with different maintenance and mowing applications and the benefits and limitations of different power sources results in a large variety of maintenance machines to meet consumer preferences.

### BRIEF SUMMARY

The following presents a simplified summary in order to provide a basic understanding of some aspects of the disclosure. This summary is not an extensive overview of the disclosure. It is not intended to identify key/critical elements or to delineate the scope of the disclosure. Its sole purpose is to present some concepts of the disclosure in a simplified form as a prelude to the more detailed description that is presented later.

Various embodiments of the present disclosure relate to a torque limiter assembly that can limit a magnitude of torque forces that are applied to a motor of a lawn maintenance device such as a mower or, particularly, an electric mower. For example, the mower device can comprise a motor assembly. The motor assembly can comprise a motor shaft and a motor configured to rotate the motor shaft. The mower device can further comprise a blade assembly that, in operation, performs a mowing function. The mower device can comprise a torque limiter assembly that is situated between and coupled to the motor assembly and the blade assembly. The torque limiter assembly can comprise a torque limiter shaft that is aligned with the motor shaft. The torque limiter assembly can comprise a first shaft coupler and a second shaft coupler. The first shaft coupler can couple to the motor shaft in a manner that transfers a torque force between the motor shaft and the first shaft coupler. The second shaft coupler can couple to the torque limiter shaft in a manner that transfers the torque force between the torque limiter shaft and the second shaft coupler. Situated between the first shaft coupler and the second shaft coupler, the torque limiter assembly can comprise a torque exchange device. The torque exchange device can comprise a friction material. The friction material in contact with the first and second shaft couplers. The friction material can be configured to limit a magnitude of the torque force transferred between the motor shaft and the torque limiter shaft.

To accomplish the foregoing and related ends, certain illustrative aspects of the disclosure are described herein in connection with the following description and the drawings. These aspects are indicative, however, of but a few of the various ways in which the principles of the disclosure can be employed and the subject disclosure is intended to include all such aspects and their equivalents. Other advantages and features of the disclosure will become apparent from the following detailed description of the disclosure when considered in conjunction with the drawings.

### BRIEF DESCRIPTION OF THE DRAWINGS

FIG. 1 provides an illustration of a convertible lawn maintenance apparatus in a seated configuration, according to disclosed embodiments.

FIG. 2 illustrates a cross section view of an example motor assembly 600, according to disclosed embodiments.

FIG. 3 illustrates an isometric view of an example blade assembly 700, according to disclosed embodiments.

FIG. 4 illustrates an exploded view of an example apparatus comprising a torque limiter assembly 800, motor assembly 600, and blade assembly 700, according to disclosed embodiments.

FIG. 5 illustrates a cross section view of an example torque limiter assembly 800, according to disclosed embodiments.

FIG. 6 illustrates a cross section view of an example torque limiter assembly 1000 including a friction surface, according to disclosed embodiments.

FIG. 7 illustrates an exploded view of the example torque limiter assembly 1000 including a friction surface, according to disclosed embodiments.

FIG. 8 illustrates a cross section view of an example torque limiter assembly 1100 having a spacer plate and multiple torque exchange devices, according to disclosed embodiments.

FIG. 9 illustrates an exploded view of the example torque limiter assembly 1100 illustrating additional aspects or detail, according to disclosed embodiments.

FIG. 10 illustrates a cross section view of an example torque limiter assembly 1200 having multiple spacer plates and multiple torque exchange devices, according to disclosed embodiments.

FIG. 11 illustrates an exploded view of the example torque limiter assembly 1200 illustrating additional aspects or detail, according to disclosed embodiments.

FIG. 12 illustrates a cross section view of apparatus 1300 with a single shaft design in which the output hub 906 is coupled to the blade assembly 700, according to disclosed embodiments.

FIG. 13 illustrates a cross section view of apparatus 1400 in which spring forces are not self-contained, according to disclosed embodiments.

FIG. 14 illustrates a close-up cross-section of an example of torque limiter assembly.

FIG. 15 illustrates an exploded view of the example torque limiter assembly of FIG. 14.

FIG. 16 illustrates a close-up cross-section of an example torque limiter assembly.

FIG. 17 illustrates an exploded view of the example torque limiter assembly of FIG. 16.

It should be noted that the drawings are diagrammatic and not drawn to scale. Relative dimensions and proportions of parts of the figures have been shown exaggerated or reduced in size for the sake of clarity and convenience in the drawings. The same reference numbers are generally used to refer to corresponding or similar features in the different embodiments, except where clear from context that same reference numbers refer to disparate features. Accordingly, the drawings and description are to be regarded as illustrative in nature and not as restrictive.

While embodiments of the disclosure pertaining to machine vision systems for power equipment machines are described herein, it should be understood that the disclosed machines, electronic and computing devices and methods are not so limited and modifications may be made without departing from the scope of the present disclosure. The scope of the systems, methods, and electronic and computing devices for machine vision devices are defined by the appended claims, and all devices, processes, and methods that come within the meaning of the claims, either literally or by equivalence, are intended to be embraced therein.

### DETAILED DESCRIPTION

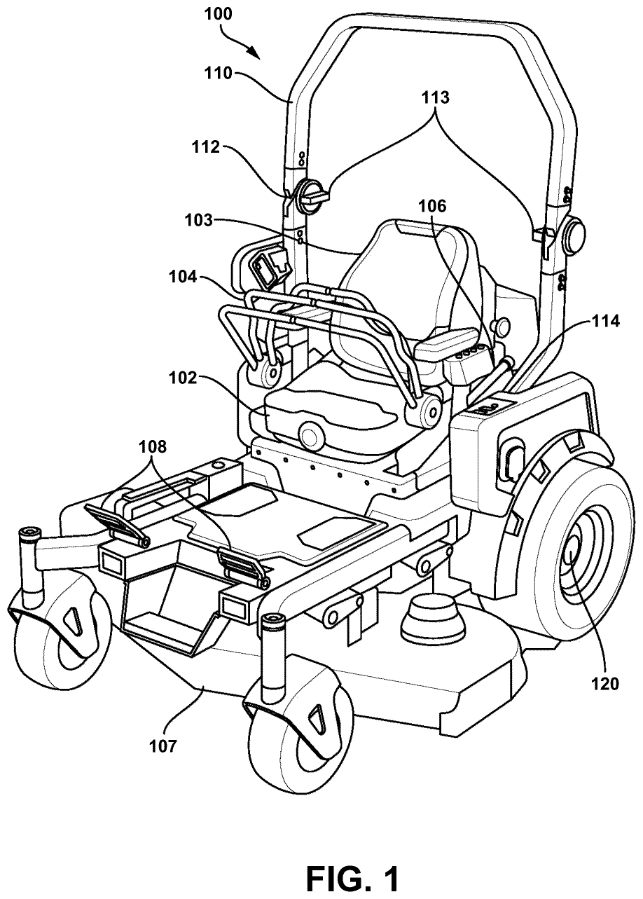

Various embodiments can comprise a lawn maintenance apparatus having multiple cutting blades, the lawn maintenance apparatus comprising a blade adapter that facilitates proper assembly of the multiple cutting blades on the lawn maintenance apparatus and/or a mounting plate that secures the multiple cutting blades according to various aspects discussed herein. As used herein, the lawn maintenance apparatus can be referred to as a “mower”, but it is understood that the lawn maintenance apparatus can relate to any suitable power equipment having multiple blades. A lawn maintenance apparatus can be a walk-behind mower with multiple cutting blades incorporated into an associated blade assembly. A lawn maintenance apparatus according to aspects discussed herein can be a ride-on lawn maintenance apparatus of any of a variety of configurations, such as a seated lawn maintenance apparatus, a standing lawn maintenance apparatus, or a convertible seated/standing lawn-maintenance apparatus, such as the example lawn maintenance apparatus described in connection with FIG. 1 below.

FIG. 1 illustrates a drawing of a first example lawn maintenance apparatus 100 employable as or in connection with various embodiments of the present disclosure. Lawn maintenance apparatus 100 is shown as a seated operator apparatus providing a seat upon which the operator can control lawn maintenance apparatus 100. However, in aspects of the disclosed embodiments lawn maintenance apparatus 100 can be a convertible standing/sitting lawn maintenance apparatus, in various embodiments. As illustrated in FIG. 1, lawn maintenance apparatus 100 is in a seated configuration, allowing an operator to ride in a seated position on an operator seat 102 with mower controls 104 for controlling powered operations of lawn maintenance apparatus 100 (e.g., drive functions, steering functions, and so forth, whether mechanical, electro-mechanical, hydraulic, pneumatic, or other suitable means of power operation), as well as electronic control or computer functions of lawn maintenance apparatus 100 (e.g., stored electronic settings, Global Positioning System (GPS) navigation, operator input controls/output indicators, status input controls/output indicators, and so forth). A mow deck 107 is provided beneath a support structure (e.g., frame, etc.) of lawn maintenance apparatus 100, and in the embodiment depicted by FIG. 1, between the front and rear wheels thereof. In various embodiments, mow deck 107 can be a high efficiency mow deck comprising the multiple blade adapter and/or mounting plate as discussed herein.

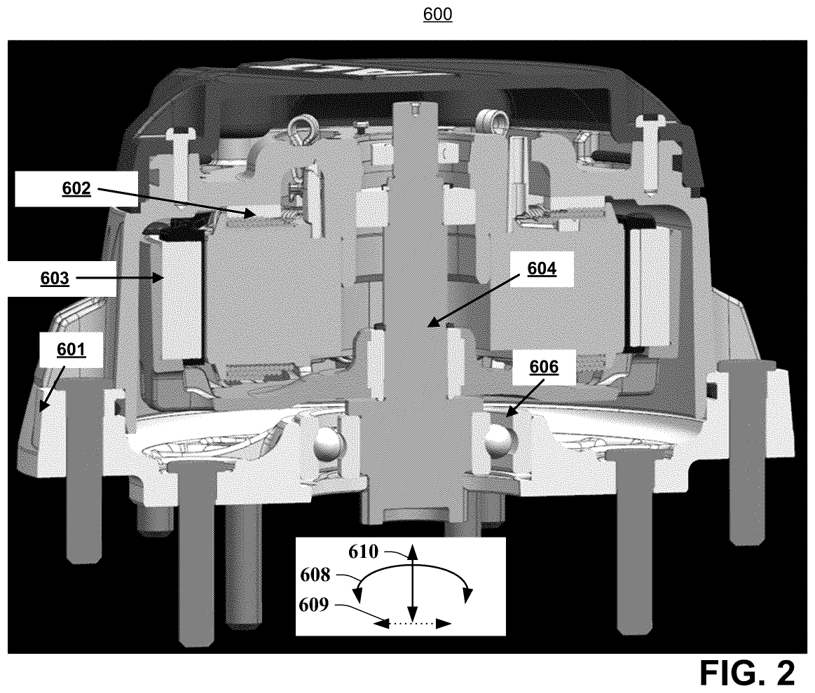

For instance, the lawn maintenance apparatus shown in FIG. 1, as well as other lawn maintenance apparatuses can include a multiple blade cutting system as well as the multiple blade adapter or mounting plate described with respect to FIGS. 2-13. Thus, the disclosed multiple blade adapter or mounting plate should not be interpreted as applicable to a single lawn maintenance apparatus, or even limited to the lawn maintenance apparatuses explicitly discussed in this specification. While a seated lawn maintenance apparatus is shown at FIG. 1, other embodiments of lawn maintenance apparatuses may include a standing lawn maintenance apparatus, and a convertible seated/standing lawn maintenance apparatus, it should be understood that these are illustrative examples only and are non-limiting. The multiple blade adapter and mounting plate are intended to be applicable to all explicitly disclosed embodiments, those not explicitly disclosed but familiar to one of ordinary skill in the art, as well as those reasonably conveyed to one of ordinary skill in the art by way of the context provided herein; all such implementations of the multiple blade adapter, the mounting plate or the multiple blade adapter and the mounting plate are considered within the scope of the present disclosure.

With reference again to FIG. 1, in various embodiments, lawn maintenance apparatus 100 can include a roll over protection (ROP) bar 110 with a ROP anchor point 114 near to a rear wheel rotation axis 120 of lawn maintenance apparatus 100. In one or more embodiments, ROP anchor point 114 can be within about 6 inches or less of rear wheel rotation axis 120. One or more footrests 108 (e.g., individual footrests 108 for each foot or a single footrest 108) can also be provided for operator comfort.

In some embodiments, lawn maintenance apparatus 100 can be mechanically changed to a standing configuration. A stand platform 130 is provided for an operator to stand upon while riding lawn maintenance apparatus 100 in a standing position. In a seated position, movable cushion 103 can be in a first position but in other configurations may to moved to a position whereby it can act as a movable cushion for a seated operator. In various embodiments, one or more of: mower controls 104, operator seat 102, movable cushion 103 and ROP bar 110 can be movable to change from the seated configuration to the standing configuration, and back again. As an example, mower controls 104 can be provided on a movable control mount 106 that can move mower controls 104 between a seated operator hand position and a standing operator hand position (not shown). As another example, movable cushion 103 can slide, pivot, rotate, or the like to a second position allowing an operator standing on stand platform 130 to lean against a portion (e.g., back or front, with the same or an inverted orientation relative to the first position, etc.) of movable cushion 103 (not shown).

In the same or other embodiments, operator seat 102 can slide, pivot, etc., to accommodate an operator standing on stand platform 130. As still another example, ROP bar 110 can fold downward away from an elevated position (as depicted by FIG. 1) by way of a ROP pivot 112. In further embodiments, any suitable combination of the foregoing can be movable parts to accommodate comfortable operator position in the seated configuration versus the standing configuration. Moreover, seated configuration and standing configuration can be selected to place the operator's head and hips at or near rear wheel rotation axis 120 to minimize centrifugal force experienced by the operator when conducting a turn of lawn maintenance apparatus 100. This head and hip position can significantly reduce unpleasant user experience resulting from tight turns, or even zero radius turns, implemented about an axis intersecting rear wheel rotation axis 120.

In still further embodiments, means for moving one or more of the movable parts (ROP bar 110, movable cushion 103, seat 102, mower controls 104, footrest 108, etc.) can be integrated into a common or linked motion so that movement of a plurality of the foregoing movable parts can be implemented by activating a single motion initiator. The motion initiator can be by mechanical (e.g., gears, pulleys, levers, pedals, bars, etc.), hydraulic, pneumatic, electro-mechanical, etc., means, resulting in movement of the plurality of movable parts, which can be one of manual, assisted manual (e.g., whereby an operator can initiate the movement with a reduced force, etc.), or automatic. As an illustrative example, an operator manually applying pressure to mower controls 104 can cause the common or linked motion means to move mower controls in conjunction with one or more of: operator seat 102, movable cushion 103, ROP bar 110, footrest 108. Said differently, an operator applying mechanical force to a mechanical motion initiator to move a first movable part (e.g., ROP bar 110, movable cushion 103, operator seat 102, mower controls 104, footrest 108, . . . ) can result in movement of the first movable part and one or more additional movable parts (e.g., ROP bar 110, movable cushion 103, operator seat 102, mower controls 104, footrest 108, . . . ). In other embodiments, the motion initiator can be a powered means such as one or more electro-mechanical motor(s), hydraulic motor(s), pneumatic motor(s) or the like, that when mechanically or electrically engaged results in movement of at least a subset of the plurality of movable parts. In such embodiments, a single control input (e.g., button press, switch turn, touch-screen activator, and so forth) can initiate the powered motion initiator. In further embodiments, a combination of mechanical and powered motion initiators are within the scope of the present disclosure. Note that in some embodiments, fewer than all movable parts can be actuated by a single motion initiator. In such embodiments, a plurality of motion initiators are provided to move respective subsets of the movable parts (e.g., a first motion initiator can be provided to move ROP bar 110, a second linked motion initiator to move both movable cushion 103 and mower controls 104, and a third motion initiator to move footrest 108; other combinations are within the scope of the present disclosure as well). In other embodiments, various elements (ROP bar 110, movable cushion 103, mower controls 104, etc.) can be independently movable, such that each can be separately adjusted between seated and standing positions without the other(s) being also adjusted between seated and standing positions.

In various embodiments, accessories could be mounted to the lawn maintenance apparatus 100. A hauling accessory (e.g., crate, box, wagon, etc.) could be mounted to a floorplate of the lawn maintenance apparatus when in standing configuration or could be mounted to stand platform 130 when in sitting configuration. In further embodiments, one or more additional seats can be provided. For instance, a foldable seat that folds out from behind movable cushion 103 or another portion of the rear of lawn maintenance apparatus 100 can be situated behind an operator in the standing configuration to briefly sit down in standing configuration. This foldable seat can have a movable cushion (similar to movable cushion 103) in an embodiment. In other embodiments, a post hole can be provided on a rear portion of lawn maintenance apparatus in which a seat-mounted post can be secured to add an additional seat in standing configuration. In yet another embodiment, when an operator stands on stand platform 130 with lawn maintenance apparatus 100 in sitting configuration, activation of movable controls to move the plurality of movable parts from the sitting configuration to the standing configuration can be implemented (e.g., in response to a pressure switch on stand platform 130 that senses a threshold weight or pressure on stand platform 130 to activate the movable controls).

The standing configuration of lawn maintenance apparatus 100 may include mower controls moved to a rear position by way of pivotable movable control mount (in rear position) near an operator's hands when standing on stand platform 130. In other embodiments controls can be moved to rear position by way of a translating slide and rail mechanism, or other suitable device. Additionally, a padded movable cushion (in forward position) may be provided for an operator to lean against when standing on stand platform 130. Likewise, ROP bar 110 may be folded forward (or rearward—not depicted) at ROP pivot 112 out of an operator's physical space and field of view when standing on stand platform 130. In various embodiments, ROP bar 110 can be folded forward up against a floor plate of lawn maintenance apparatus overlying mow deck 107 and in front of footrest 108. In other embodiments ROP bar 110 can be folded behind (and optionally tucked under) a padded movable cushion.

Alternative embodiments may permit transition from a standing configuration to seated configuration for a lawn maintenance apparatus 100. Merely putting a stand platform 130 on a rear end of a lawn maintenance apparatus 100 in sitting configuration is, in some embodiments, not sufficient to allow the operator to operate lawn maintenance apparatus 100 comfortably in a standing position. Accordingly, ROP bar 110 may be rotated, pivoted or shifted forward to provide a resting surface for the legs and hips of the operator. Likewise, controls may be moving back toward the operator's hands in standing position.

According to alternative or additional embodiments of the present disclosure a lawn maintenance apparatus may comprise a front mounted deck positioned in front of drive wheels 408 and forward of caster wheels 406. A front mounted lawn maintenance apparatus can similarly be changed between a seated configuration and a standing configuration as noted above.

In a front mounted lawn maintenance apparatus in a standing configuration an operator may have the controls in a rear position coincident with their hands' natural position when standing on stand platform.

### Example Torque Limiter Assemblies

While FIG. 1 and the disclosures above relate to example lawn maintenance apparatuses, the remainder of the Figures are generally directed to various torque limiter assemblies for motors such as those associated with lawn maintenance apparatuses described above and in FIG. 1 that perform mowing functions. In some embodiments, the torque limiter assembly can be specific to electric motors or motors that drive a blade assembly having multiple blades.

In recent times, the lawn maintenance industry has seen a push toward battery powered machinery, moving away from conventional combustion engines. One challenge associated with this transition is that current battery-powered and/or electric motors can sustain damage differently than other motors in the context of existing designs.

For example, in operation, when a blade of a lawn maintenance apparatus contacts a large or well-anchored object, such as, for example, a fence post, such can induce a sudden stop event. When the blade or blades have been rapidly stopped, the deck motor, which is driving the shaft to rotate the blades, has a significant amount of energy. If this energy is not dispersed in a controlled manner, damage can occur.

Previous combustion-type deck motors are driven by belt and pulley systems, which provide an inherent torque-limiting function. For instance, in the face of a sudden stop event such as that described in the above example, the belts would simply slip, albeit in an imprecise and unpredictable way. This belt slippage can operate to prevent damage to internal components of the motor that may result from torsion forces.

However, in the case of electric motors, which do not have the same belt and pulley structure, sudden stop events or other damage-inducing events can cause more severe damage to internal components. As an example, an electric motor and flywheel that rotates a drive shaft that turns a blade system can generate significant inertia in the rotating blade system. In response to impacting a rigid object the inertia in the rotating blade system results in significant energy that is transferred to, and potentially damaging, the internal components of the electric motor through a rigid coupling with the drive shaft and blade system (as opposed to the belt and pulley system that allows for belt-slip). This damage can be mitigated or avoided by embodiments of the present disclosure.

To these and other ends, the disclosed subject matter is directed to a torque limiter assembly that can mitigate potential damage to a motor of a lawn maintenance apparatus or other suitable apparatus. For example, the torque limiter assembly can be configured to cap rotational inertia transferred from a blade system to the motor. The torque limiter assembly is not limited to mitigating damage from rotational forces, but can, in some embodiments, operate to mitigate damage from certain axial, transverse or other forces as well. Hence, various embodiments of the torque limiter assembly can also be referred to herein as a damage mitigation assembly that can operate to mitigate potential damage to the motor that can arise from forces or loads from multiple directions and sources.

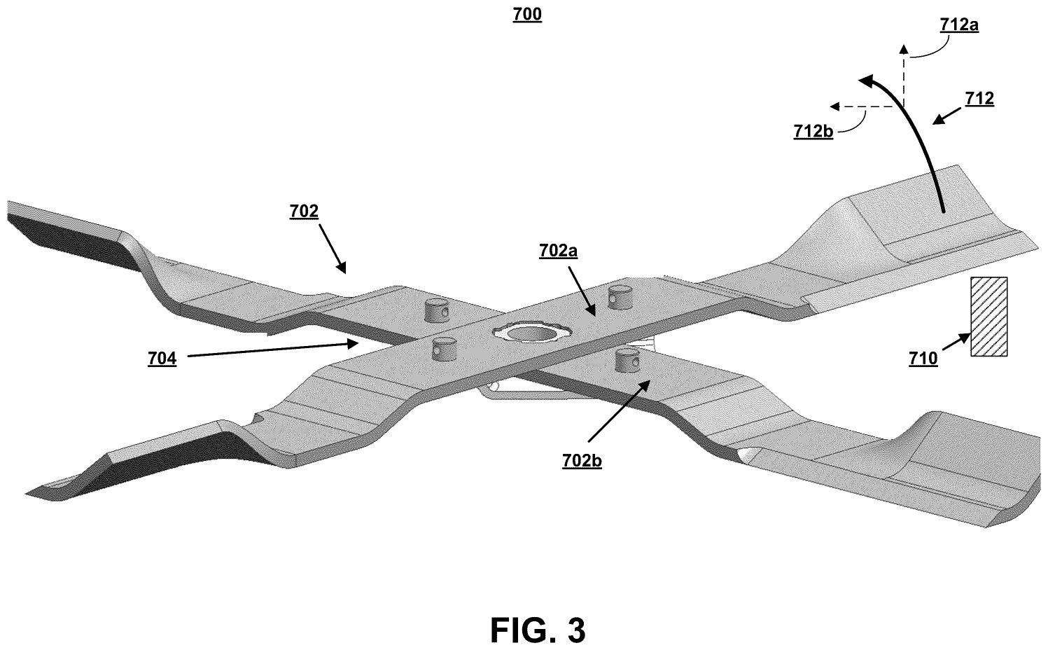

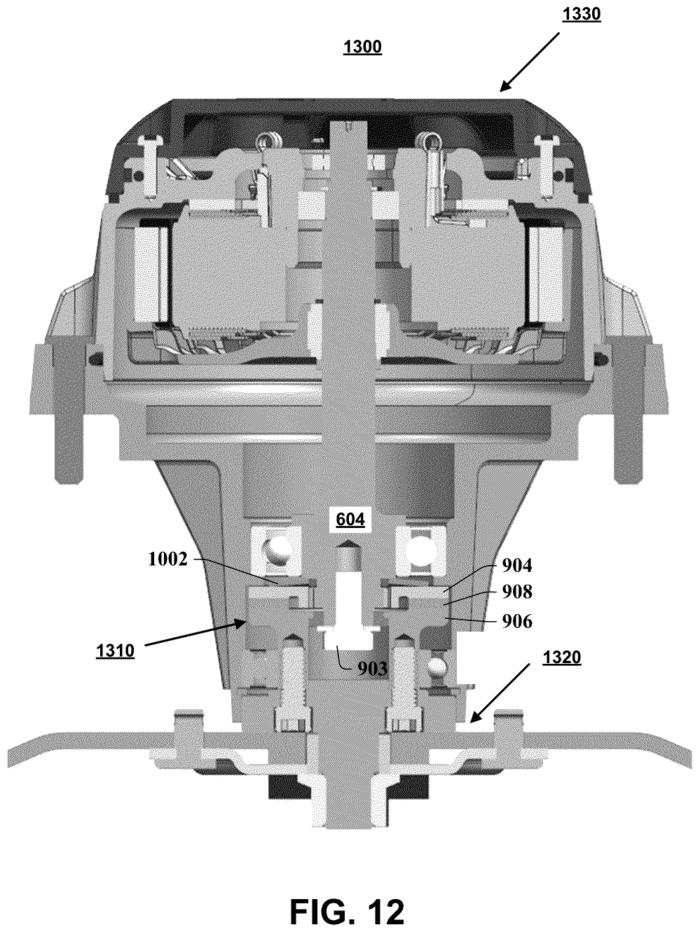

In some embodiments, the torque limiter assembly can be modular in design, which is further detailed herein. In some embodiments, the torque limiter assembly can be situated between a motor assembly (discussed in connection with FIG. 2) and a blade assembly (further detailed in connection with FIG. 3). In alternative embodiments, the torque limiter can be non-modular, and incorporated at least in part within a motor assembly (e.g., see FIG. 12, infra). To better impart certain aspects or advantages of the torque limiter assembly, an example of the associated motor assembly and blade assembly, to which the torque limiter assembly can be coupled are now described.

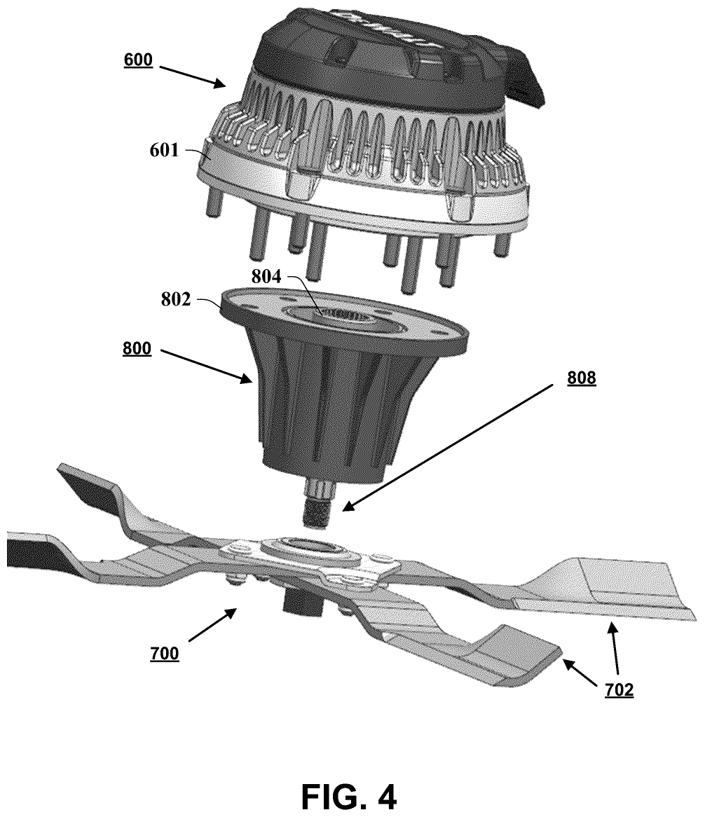

With reference now to FIG. 2, a cross section view of an example motor assembly 600 is illustrated, though simplified for purposes of clarity, according to disclosed embodiments. In the context of modularity, motor assembly 600 can comprise mounting plate 601 that can provide a secure mounting to the various disclosed torque limiter device (e.g., torque limiter assembly 800 of FIG. 4). Motor assembly 600 can comprise electric motor 602. While electric motor 602 is a representative example used herein, it is appreciated that other types of motors such as combustion motors are within the scope of this disclosure. As noted previously, other motors may have belt and pulley systems or other systems that effectively limit certain torque forces from being absorbed by the associated motor. However, these systems are not typically precise or predictable and therefore may operate in unexpected ways and/or may not reliably prevent certain damage. Thus, while electric motor 602 is representative, potentially, other types of motors can benefit from the torque limiter devices and techniques detailed herein.

Electric motor 602 can be configured to rotate flywheel 603, which can represent a primary energy store device for electric motor 602. Kinetic energy stored in flywheel 603 can lead to damage from a sudden stop event, if not limited in some way. Flywheel 603 can be coupled to motor shaft 604, for instance via a press fit or the like. Rotation of motor shaft 604 can, in turn, cause a coupled blade assembly to rotate. While still referring to FIG. 2, but turning now as well to FIG. 3, an isometric view of an example blade assembly 700 is illustrated, according to disclosed embodiments. Blade assembly 700 is not necessarily limited to a single blade. Rather, blade assembly 700 can comprise multiple blades 702. More specifically, blade assembly 700 can comprise one, two, three, four, or more blades. In this example, blade assembly 700 has two blades, indicated as first blade 702a and second blade 702b, each having multiple cutting edges (e.g., two cutting edges). The multiple blades 702a, 702b can be offset at an angle 704 about an axis of rotation of blade assembly 700 by about 90 degrees. In some embodiments, this angle 704 can be in a range of 80 degrees to 100 degrees, a range of 70 degrees to 110 degrees, a range of 60 degrees to 120 degrees, or any suitable value or suitable range there between.

Still referring jointly to FIGS. 2 and 3, while there are many types or sizes of motors and blade assemblies, to provide a representative, but non-limiting, example, suppose electric motor 602 drives the associated blade assembly 700 up to maximum of about 4200 rotations per minute (rpm), where the maximum speed is attained after about 1.5 seconds of throttle. Testing shows in that case, motor shaft 604 transfers about 10-12 pound-feet (lb-ft) of torque (e.g., in torque direction 608) to the blade assembly in order to spin it up to about 4200 rpm for a typical lawn maintenance apparatus arrangement. On the other hand, when electric motor 602 is at full speed, if a blade of the blade assembly 700 contacts an object 710 causing a sudden stop event such as contact with a fence post per the previous example, then the amount of torque that is applied to components of motor assembly 600 (without a torque limiting device as described herein) to disperse the inertia of electric motor 602 can be about 270 lb-feet. A force 712 upon blade assembly 700 can have an axial component 712a, a transverse component 712b or a combination of the axial component 712a and transverse component 712b.

Regardless of the design, such (or similar) amounts of torque applied to internal components of electric motor 602 can cause damage. In addition, the sudden stop event can also result in a significant amount of axial force 712a (e.g., in axial direction 610) or transverse force 712b (e.g., in transverse direction 609) transferred to electric motor 602 and/or motor assembly 600. For example, when the blade strikes the fence post (object 710), the momentum of the blade will tend to cause the blade to “ride up” on the fence post, transferring axial forces 712a through motor shaft 604 (and potentially transverse force 712b on motor shaft 604). In some embodiments, motor assembly 600 can comprise motor bearings 606 that can mitigate some of the forces in axial direction 610 or a transverse direction 609, but such can cause wear and damage to motor bearings 606 and other internal components.

In order to mitigate damage to motor assembly 600 or components thereof such as in response to a sudden stop event or other damage-inducing event, a torque limiter assembly can be included, an example of which is illustrated in connection with FIG. 4.

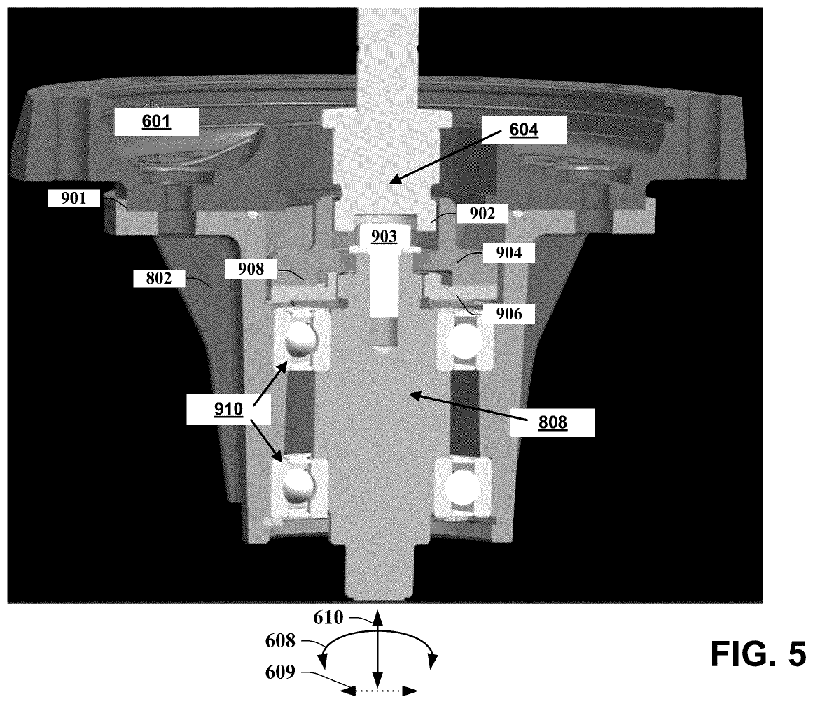

With reference now to FIG. 4, an exploded view of an example apparatus comprising a torque limiter assembly 800, motor assembly 600, and blade assembly 700 is illustrated, according to disclosed embodiments. As mentioned, torque limiter assembly 800 can operate to limit torque forces, axial forces, transverse forces or other forces that might otherwise damage components of motor assembly 600. Non-limiting examples of torque limiter assembly 800 are discussed in greater detail in connection with FIGS. 5-13.

In some embodiments, torque limiter assembly 800 can be situated between and coupled to a motor assembly and a blade assembly, such as, e.g., motor assembly 600 that was introduced in connection with FIG. 2, and blade assembly 700 that was introduced in connection with FIG. 3.

In some embodiments, torque limiter assembly 800 can comprise sealed housing 802 that can be coupled to motor assembly 600 in a modular manner. This modular nature of torque limiter assembly 800 can provide benefits in that, inter alia, if damage is sustained from a sudden stop event or otherwise, such damage can be limited to elements of torque limiter assembly 800 rather than being sustained by elements of motor assembly 600, the latter of which is typically much more expensive to service, repair, or replace. The modular nature can also support retrofit embodiments, which can increase the applicability or usage and potentially reduce part number maintenance or the like.

Sealed housing 802 can operate to protect internal components (examples of which are described in more detail in connection with FIGS. 5-13) from contaminants such as dust, water, or other contaminants, and can also secure internal components from unauthorized interference. In some embodiments, motor shaft 604 can extend through torque limiter assembly 800 to couple directly to blade assembly 700 (e.g., see FIG. 12). In other embodiments, as illustrated in this example, motor shaft 604 can interface with an upper portion of torque limiter assembly 800, while an independent shaft (e.g., torque limiter shaft 808) interfaces with blade assembly 700. As one example, torque limiter assembly 800 can comprise a spline assembly 804 (see also shaft coupler 904 of FIG. 5, infra) that mates to a corresponding spline assembly of motor assembly 600 (e.g., see splines 902 of FIG. 5, infra) that, in this perspective is occluded by mounting plate 601. Other types of interfaces, apart from the spline connection illustrated here, can be suitable as well.

Hence, in some embodiments, torque limiter assembly 800 can have a separate shaft (e.g., torque limiter shaft 808) that can be aligned with and mechanically linked to motor shaft 604. Within this mechanical linkage between motor shaft 604 and a similarly aligned torque limiter shaft 808, numerous mechanical or functional aspects can exist that will become more clear with reference to subsequent figures.

Turning now to FIG. 5, a cross section view of an example torque limiter assembly 800 is illustrated, according to disclosed embodiments. As illustrated, mounting plate 601 of motor assembly 600 can provide an interface and securing mechanism between motor assembly 600 and torque limiter assembly 800 such as via a securing mechanism that couples to sealed housing 802 or by other means. The securing mechanism can include any suitable type of bolt, bolt and nut combination, stud and nut combination, screw, mounting pin, peg, rivet, clamp, anchor, retaining ring, screw anchor, strap, latch, wedge anchor, nail, cam dowel and lock, and so forth. In other embodiments, mounting plate 601 can be secured to torque limiter assembly 800 and sealed housing 802 by permanent means, such as welding, crimping, cementing, soldering, brazing, and so forth. To aid in proper alignment between motor assembly 600 and torque limiter assembly 800, an upper surface of sealed housing 802 can comprise a pilot guide 901 to, e.g., guide coupling of mounting plate 601.

As mentioned, torque limiter shaft 808 can be aligned with motor shaft 604. An upper portion can be enclosed by a housing such as a sealed housing 802, with a lower portion extending outside sealed housing 802 adapted to couple to blade assembly 700. Elements intended for coupling to blade assembly 700 can have a different design vis-à-vis motor shaft 604 or the same design, such as in the case of a retrofit embodiment.

Potentially disposed within sealed housing 802, torque limiter assembly 800 can comprise first shaft coupler 904 (also referred to herein as an input hub 904). Input hub 904 can couple to motor shaft 604 by any suitable means (e.g., torsion coupling). In this example, input hub 904 is axially retained via bolt 903 and torsion-coupled to motor shaft 604 via mated spline assemblies 804, representing a portion of input hub 904, and splines 902 at a lower portion of motor shaft 604. Other types of coupling are envisioned, such as fasteners, a clutch(es) (e.g., an externally actuated clutch(es)), a belt and pulley, and so forth, provided input hub 904 and motor shaft 604 are coupled in a manner that transfers torque force between motor shaft 604 and input hub 904.

Torque limiter assembly 800 can further comprise second shaft coupler 906 (also referred to herein as an output hub 906). Output hub 906 can couple to torque limiter shaft 808 by any suitable means (e.g., fastener(s), clutch(es), belt(s) and pulley(s), etc.) with mated splines or spline assemblies serving as representative, though non-limiting, examples. Hence, output hub 906 can couple to torque limiter shaft 808 in any suitable manner that transfers torque force between torque limiter shaft 808 and output hub 906.

It is noted that while input hub 904 can be directly coupled to motor shaft 604, input hub 904 is not directly coupled to torque limiter shaft 808. Likewise, while output hub 906 can be directly coupled to torque limiter shaft 808, output hub 906 is not directly coupled to motor shaft 604. Rather, situated between input hub 904 and output hub 906 is torque exchange device 908. Torque exchange device 908 can comprise a friction material that contacts both input hub 904 and output hub 906. In operation, torque exchange device 908 can be configured to, via the friction material, limit a magnitude of the torque force transferred between motor shaft 604 (e.g., via input hub 904) and torque limiter shaft 808 (e.g., via output hub 906).

Hence, the friction material or, more generally, torque exchange device 908, can operate to limit torque transfer between input hub 904 and output hub 906 and thus, by proxy, between motor shaft 604 and torque limiter shaft 808. That is, provided the torque force between motor shaft 604 and torque limiter shaft 808 does not exceed some upper limit set by a coefficient of static friction or other configurable element related to the friction material, then all or virtually all torque forces applied to one shaft (motor shaft 604; torque limiter shaft 808) that are below the upper limit on transferable torque can be transferred to the other shaft (torque limiter shaft 808; motor shaft 604, respectively). However, if the torque force exceeds that upper limit, then slippage can occur, preventing at least some torque force from one shaft being transferred to the other.

Further to the above, friction slipping between torque exchange device 908 and either input hub 904 or output hub 906 causes a coefficient of kinetic friction (or other configurable element) associated with torque exchange device 908 to govern transfer of friction between input hub 904 and output hub 906, which is lower than the coefficient of static friction. Accordingly, in response to friction slipping, the torque transferred between motor shaft 604 and torque limiter shaft 808 by torque exchange device 908 drops significantly, and remains at a lower level of torque transfer until the friction slipping ceases and the coefficient of static friction again governs transfer of friction between torque exchange device 908 and input hub 904 and output hub 906.

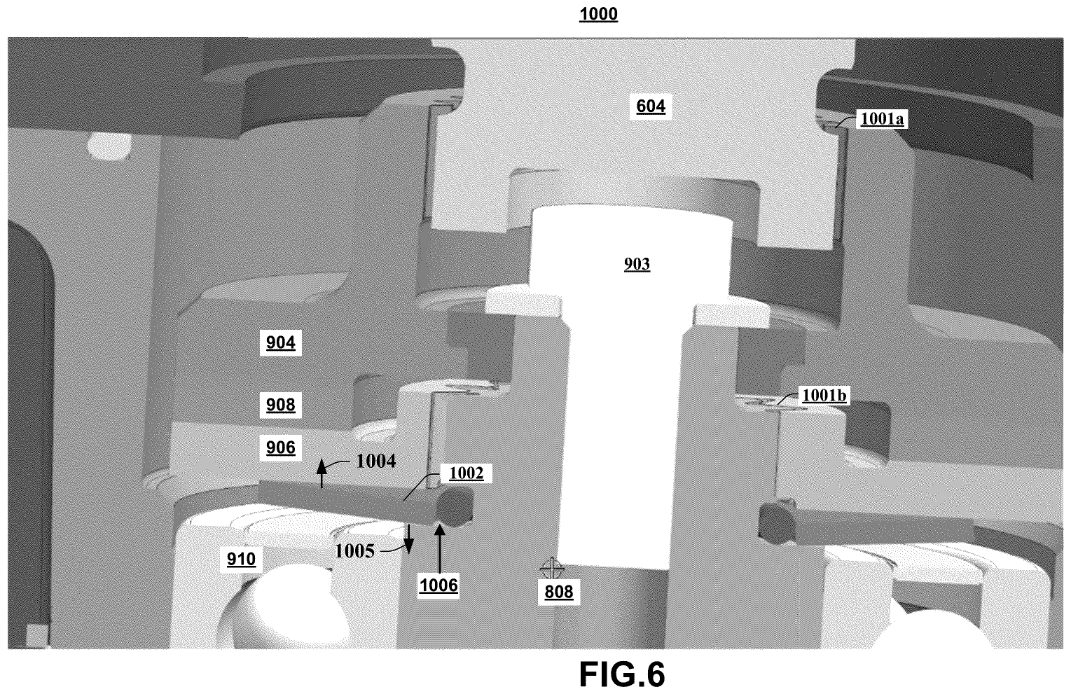

In one or more embodiments, the friction of torque exchange device 908 can be selected and/or configured to limit the magnitude of the torque force transferred between motor shaft 604 and torque limiter shaft 808 to be less than a target magnitude. The friction can be selected by choice of a material utilized for torque exchange device 908, by configuration of a force applied upon torque exchange device 908 (e.g., an axial force applied by mechanical spring force device 1002 of FIG. 6, infra), or the like, or a suitable combination of the foregoing. In some embodiments, this defined magnitude can be selected as a function of some characteristic of an associated motor, such as electric motor 602. For example, the defined magnitude can be a function of, e.g., a type of the motor, a size of the motor, a maximum rotational speed of the motor, a reverse torque specification limit, and so forth. Generally, this defined magnitude will be determined to be greater than a maximum force output produced by the associated motor (e.g., electric motor 602) such that slippage will not occur during spin up or normal operation, but rather only when subjected to extreme forces such as those generated by a sudden blade stoppage or the like.

In some embodiments, torque exchange device 908 can be bonded, e.g., by glue, epoxy, cement, weld, crimp, or another suitable material or technique, or can be fastened by a fastening device (e.g., rivet, pin and nut, bolt and nut, or other fastening device disclosed herein) to one or the other of input hub 904 and output hub 906. Securing torque exchange device 908 at one surface to input hub 904 or output hub 906 can cause friction slippage at a selected contact interface, that is, either between the friction material and input hub 904 or between the friction material and output hub 906, but is unlikely to occur at both interfaces. This can make configuration of the frictional slippage more reliably controlled. In some embodiments, the friction material can comprise at least one of a group comprising: an organic friction material, a ceramic friction material, a metallic friction material, a non-metallic friction material, or the like, and combinations (including, e.g., mixtures and alloys) or compounds thereof.

In some embodiments, torque limiter assembly 800 can further comprise bearing device 910. Bearing device 910 can be configured to reduce a magnitude of an axial force (e.g., in axial direction 610) or a transverse force (e.g., in transverse direction 609) that is transferred from torque limiter shaft 808 to motor shaft 604. In some embodiments, bearing device 910 can comprise a single set of bearings, or multiple sets of bearings, as illustrated here. As illustrated, bearing device 910 comprises two sets of bearings that are, respectively, distributed axially at some separation distance along torque limiter shaft 808. It is understood that bearing device 910 can comprise one, two, or more distinct sets of bearings.

Hence, bearing device 910, situated in torque limiter assembly 800, can operate to absorb axial forces 712a and/or transverse forces 712b that would otherwise be applied to motor bearings 606 or other components of motor assembly 600. Such can mitigate wear or damage to components of motor assembly 600. Likewise, as detailed, torque exchange device 908 can operate to limit a magnitude of torque (e.g., in torque direction 608) exchanged between the two distinct shafts 604, 808. Thus, torque limiter assembly 800 can operate to reduce magnitudes of many different forces that would otherwise be applied to motor assembly 600, thereby preventing, mitigating, or reducing potential wear or damage to motor assembly 600.

For example, as noted previously in the context of a typical lawn maintenance device (without torque limiter assembly 800) undergoing a sudden stop event, about 270 lb-ft of torque would be applied to motor assembly 600 (or, e.g., a torque in a range of 250-300 lb-ft), which could cause significant wear or damage to internal components of motor assembly 600. On the other hand, with torque limiter assembly 800, the same sudden stop event would apply only about 16 lb-ft of torque (or, e.g., a torque in a second range of 10-30 lb-ft) to motor assembly 600 or components thereof, with the remainder being absorbed by torque limiter assembly 800.

As one consequence, motor assembly 600 can be designed more efficiently and/or more inexpensively, since such motors will not be expected to contend with extreme forces, even in the face of a sudden stop event or the like. These extreme, potentially wear-inducing or damage-inducing, forces can instead be absorbed by torque limiter assembly 800, which can be specifically designed to handle such forces. Should significant wear or damage occur to the product, such is likely to be limited to components of torque limiter assembly 800 rather than occurring in components of motor assembly 600. Due in part to the modular nature in some embodiments, torque limiter assembly 800 can typically be repaired or replaced at a significantly lower cost than a similar repair to, or replacement of, motor assembly 600 (e.g., by unfastening torque limiter assembly 800 from motor assembly 600 and motor shaft 604; see FIGS. 4 and 5).

Turning now to FIG. 6, a cross section view of an example torque limiter assembly 1000 is illustrated showing additional aspects or detail, according to disclosed embodiments. As illustrated here again, motor shaft 604 is coupled, via spline interfaces 1001a, to input hub 904 such that torque is readily transferred therebetween. Likewise, torque limiter shaft 808 is coupled, via separate spline interfaces 1001b, to output hub 906 such that torque is readily transferred therebetween. Situated between, and in contact with, input hub 904 and output hub 906 is torque exchange device 908, comprising a friction material as described herein.

As detailed, torque exchange device 908 can operate to transfer torque forces between motor shaft 604 and torque limiter shaft 808 up to a defined magnitude, beyond which friction slippage will occur. Such friction slippage can over time cause wearing or thinning of torque exchange device 908 and/or the associated friction material. As noted, while one contact interface of torque exchange device 908 can be bonded (e.g., to either input hub 904 or output hub 906), in order to ensure that suitable contact at the other contact interface is maintained, even in the face of wear or thinning, torque limiter assembly 1000 can comprise a mechanical spring force device 1002. Mechanical spring force device 1002 can be configured to apply a continuous force 1004, either directly or indirectly, to torque exchange device 908. This continuous force 1004 can be configured to be sufficient to maintain sufficient contact between the friction material and an associated coupler (e.g., either or both of input hub 904 and output hub 906) to maintain a coefficient of static friction at a selected value or range of values. Additionally, mechanical spring force device 1002 can maintain continuous force 1004 in view of potential wear to the friction material, thermal expansion, thermal contraction, or other forces or phenomena that might affect friction material contact and/or friction coefficients.

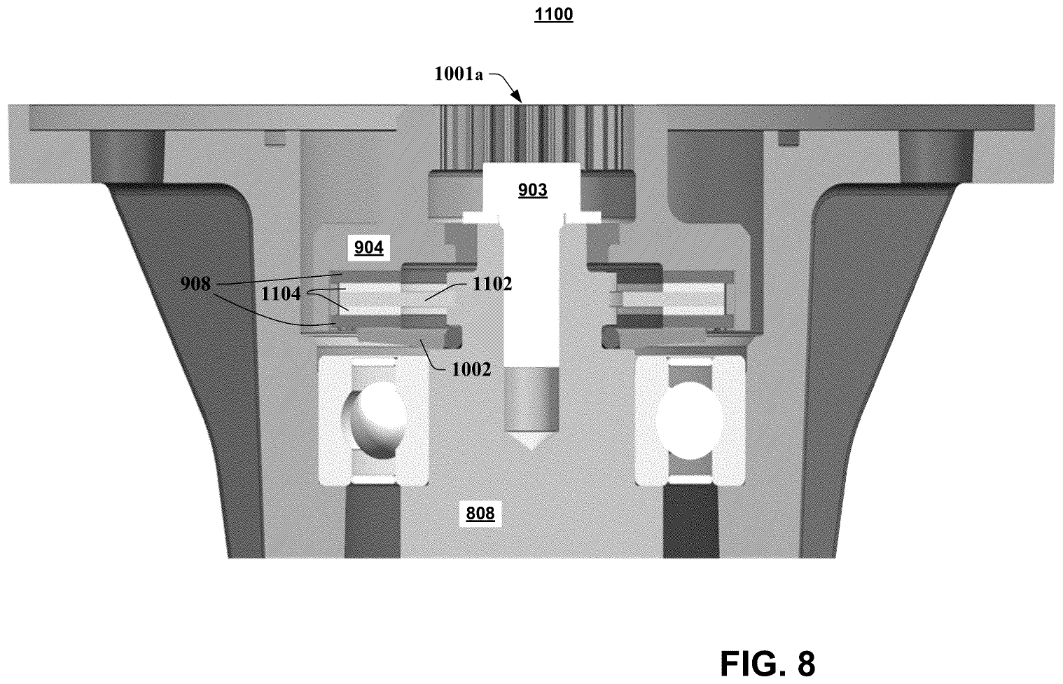

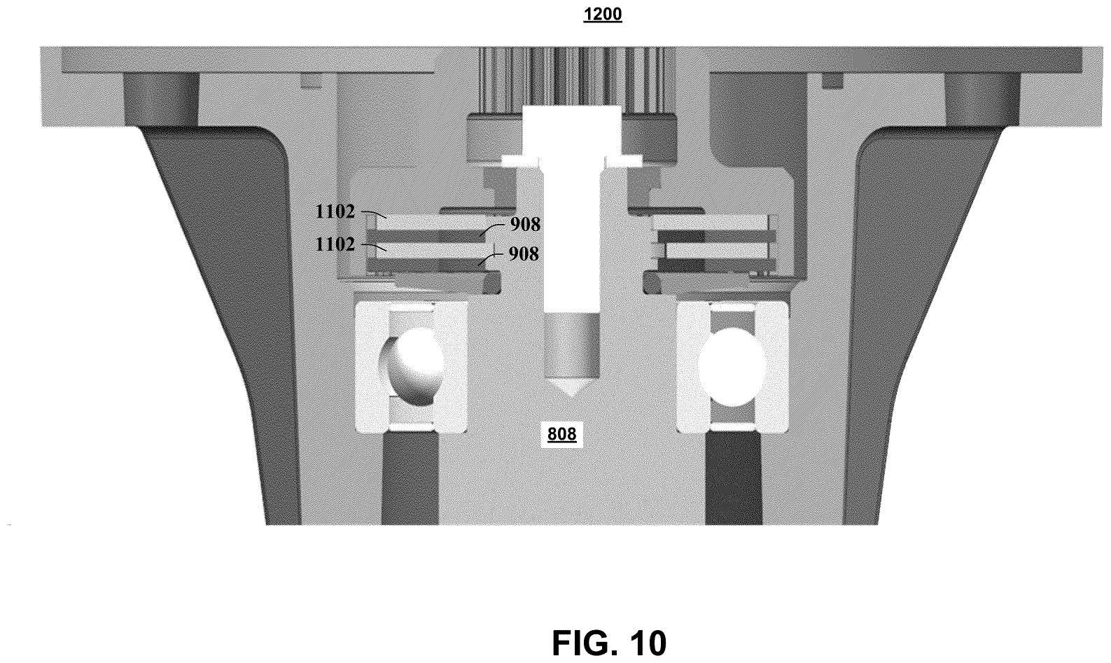

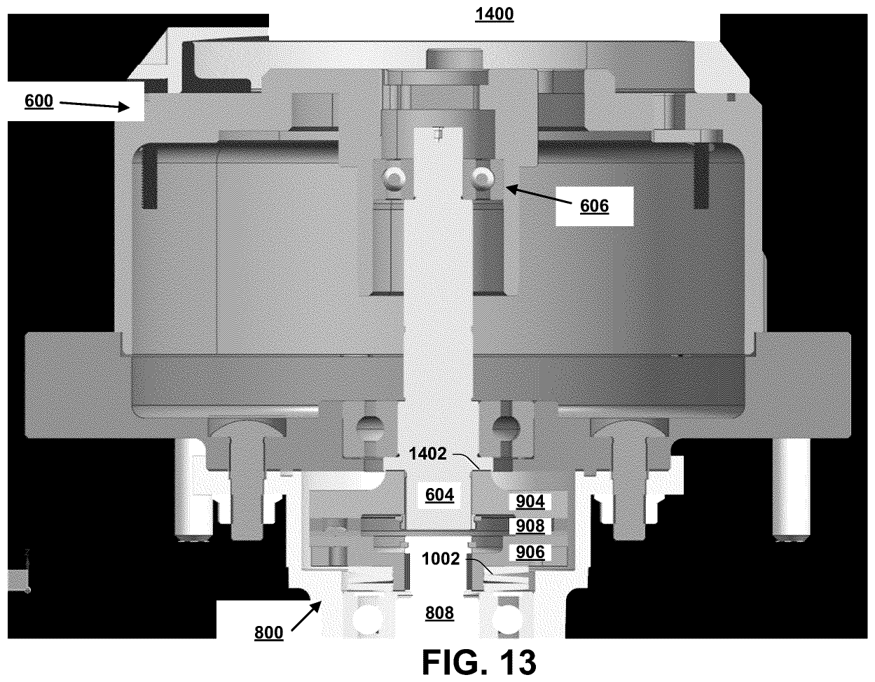

In this example, mechanical spring force device 1002 directly applies continuous force 1004 to output hub 906, which is transferred to torque exchange device 908 such that sufficient contact can be maintained at the contact interfaces of torque exchange device 908. It is understood that other arrangements are envisioned, apart from the example illustrated here. For instance, in other embodiments, mechanical spring force device 1002 might be situated elsewhere and apply continuous force 1004 to other components such to as input hub 904 (see FIG. 12), to output hub 906, as here (see also FIG. 13), or a spacer plate or torque exchange device 908 (not shown but see FIGS. 8 and 10).

Mechanical spring force device 1002 can be any suitable device for generating continuous force 1004 or otherwise serving to maintain sufficient contact for a friction material of torque exchange device 908. Examples can include a Belleville washer or similar, a leaf spring or similar, any other suitable spring device such as a compression coil spring, etc., or another suitable linear mechanical force device (e.g., a piston or bladder pressurized to apply force hydraulically, pneumatically, etc., in a fixed permanent manner or by external control mechanism—not depicted; the latter could allow the linear mechanical force to be reduced or disengaged, analogous to a release of a clutch). The current illustration depicts an example Belleville washer arrangement.

The current illustration also illustrates ledge 1006 (also referred to as shoulder 1006) of torque limiter shaft 808, upon which a portion of mechanical spring force device 1002 is situated. Hence, in this example, opposing force 1005 (e.g., resulting from continuous force 1004 being applied to output hub 906) is applied to ledge 1006. It is also to be noted that continuous force 1004 (or a portion thereof) represent an axial force that is transferred through output hub 906, torque exchange device 908 and input hub 904, to bolt 903. Thus, no axial forces due to spring force device 1002 are transferred beyond torque limiter shaft 808, but rather are bounded between shoulder 1006 of torque limiter shaft 808 and bolt 903 that is coupled to torque limiter shaft 808. Such can be referred to as a self-contained spring force embodiment. Other embodiments are envisioned. For example, as one alternative, opposing force 1005 can instead be applied to bearing device 910 (or shoulder 1006) and a bearing device (e.g., motor bearings 606) of motor assembly 600, which would not be referred to as self-contained. An example that is not self-contained is illustrated with reference to FIG. 13.

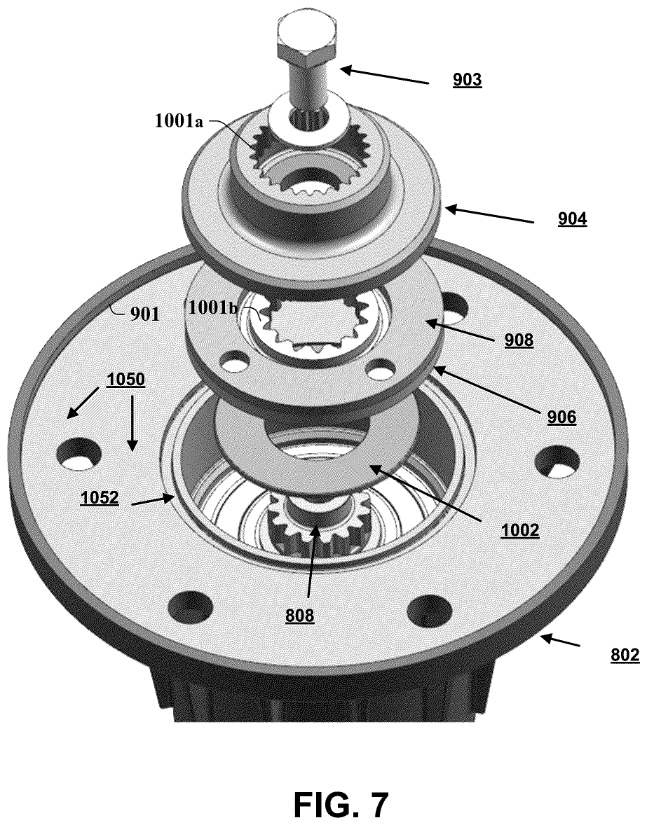

FIG. 7 depicts an exploded view of example torque limiter assembly 1000 illustrated showing additional aspects or detail, according to disclosed embodiments. At an upper portion of sealed housing 802, mounting plate interface 1050 is illustrated. Mounting plate interface can serve as a surface to which mounting plate 601 can be coupled to mounting plate interface 1050, and be properly aligned via pilot guide 901. A conventional O-ring may be installed in O-ring channel 1052 to aid in sealing and the modularity of torque limiter assembly 1000. Mechanical spring force device 1002, output hub 906, torque exchange device 908, and input hub 904 can be assembled as illustrated. These elements can be secured axially via bolt 903 and rotationally via various spline interfaces (e.g., spline interfaces 1001a, 1001b).

In this example, splines 1001a of input hub 904 couple to associated splines of motor shaft 604. In contrast, spines 1001b of output hub 906 couple to associated splines of torque limiter shaft 808. In general, in this and subsequent Figures, splines 1001a are rotationally coupled to motor shaft 604, while splines 1001b are rotationally coupled to torque limiter shaft 808. Such further illustrates differences among this and other embodiments.

Referring now to FIGS. 8 and 10, various additional embodiments are depicted. FIG. 8 depicts a cross section view of an example torque limiter assembly 1100 having a spacer plate and multiple torque exchange devices 908, according to disclosed embodiments. FIG. 10 depicts a cross section view of an example torque limiter assembly 1200 having multiple spacer plates and multiple torque exchange devices 908, according to disclosed embodiments. Spacer plates 1102 can be specifically configured for interface with friction material 1104 of torque interface device 908. Hence, spacer plates 1102 can be in direct contact with the friction material instead of input hub 904 and/or output hub 906. Spacer plates 1102 can, via coupling techniques such as spline coupling or otherwise as known in the art or described herein, be configured to transfer torque forces to one or the other of motor shaft 604 or torque limiter shaft 808. Thus, spacer plates 1102 can operate as intermediate shaft couplers having direct contact with torque exchange device 908, and in some embodiments, operate as output hub 906.

In this example, spacer plate 1102 is situated between two torque exchange devices 908. Outer portions of torque exchange devices 908, e.g., composed of a metal respective contact input hub 904 and mechanical spring force device 1102. Inner portions of torque exchange device 908, composed of friction material 1104 are in contact with spacer plate 1102. Spacer plate 1102 replaces output hub 906 entirely, while preventing mechanical spring force device 1002 from making direct contact with friction material 1104, and can be coupled to torque limiter shaft 808 (e.g., by spline coupling, fastener(s), welding, bonding, and so forth).

One advantage of multiple frictions surfaces, as in this example, is that a given spring force (e.g., continuous force 1004) magnitude that is provided by mechanical spring force device 1002 results in multiples of the amount of torque force that can be transferred without slippage.

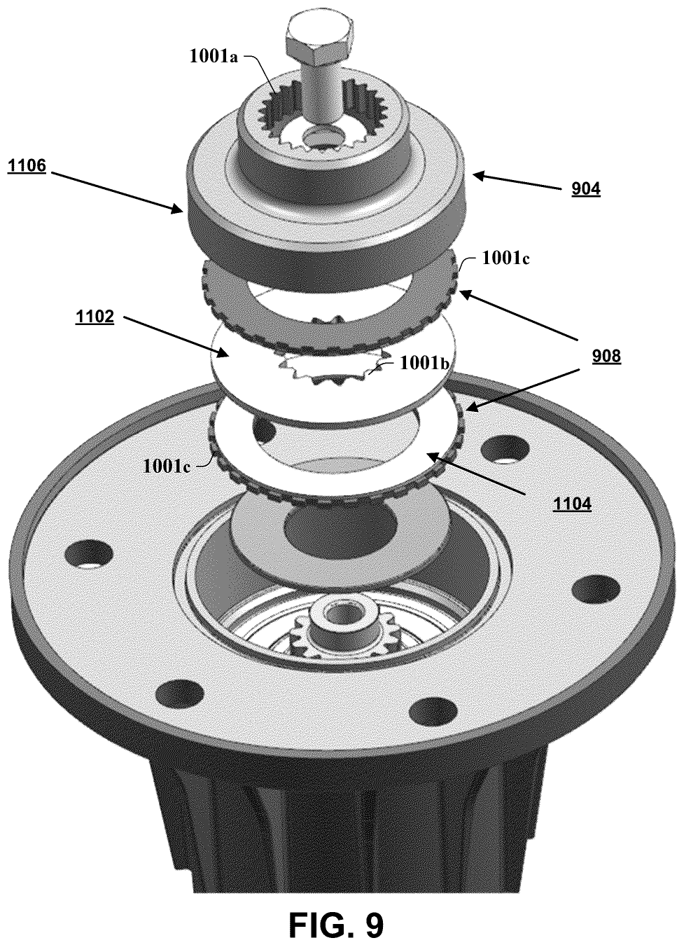

FIG. 9 depicts an exploded view of example torque limiter assembly 1100 illustrated showing additional aspects or detail, according to disclosed embodiments. Common elements detailed and described previously are depicted here, such as many of the elements illustrated and described in FIGS. 6 and 7. In addition, as depicted here, example torque limiter assembly 1100 comprises spacer plate 1102 enclosed by two torque exchange devices 908. While occluded in the depiction of the upper instance of torque exchange device 908, friction material 1104 is visible in the lower instance of torque exchange device 908.

In this example, spacer plate 1102 has splines 1001b that couple to torque limiter shaft 808. As in previous examples, input hub 904 comprises splines 1001a that couple to motor shaft 604. In addition, although occluded in this view, an interior portion of vertical band 1106 of input hub 904 comprises matching splines that mate with splines 1001c of torque exchange device 908. Thus, torque exchange devices 908 are rotationally coupled to motor shaft 608 (via input hub 904), spacer plate 1102 is rotationally coupled to torque limiter shaft 808, with friction material 1104 serving as the frictionally-bound interface between the two.

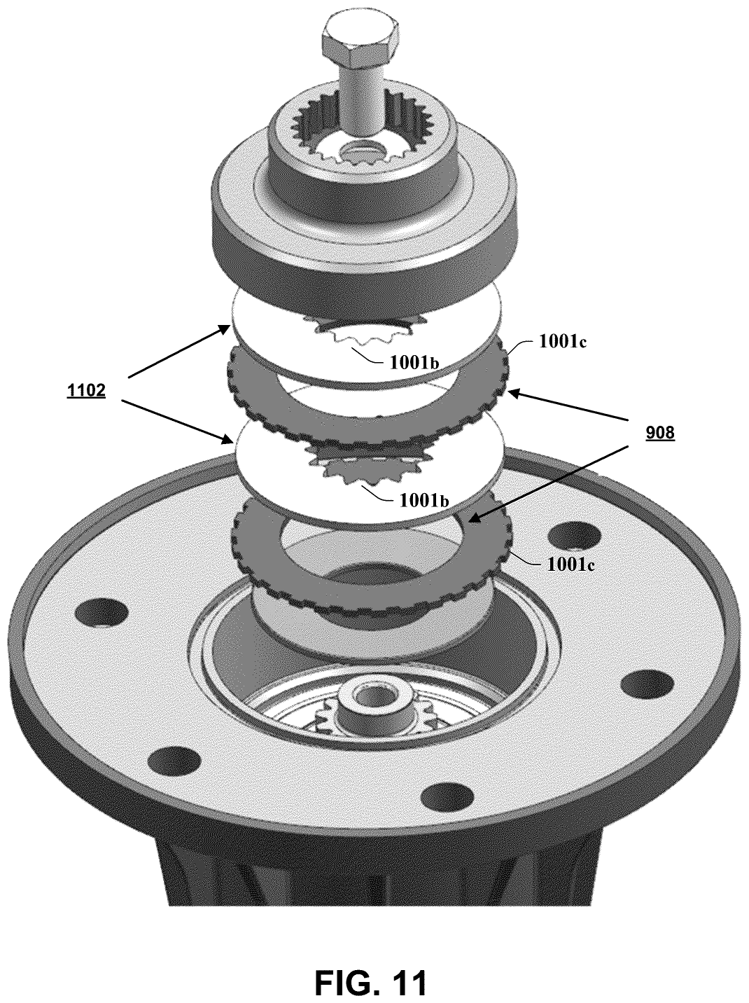

With reference to FIGS. 10 and 11, an example torque limiter device 1200 is shown having multiple spacer plates and multiple torque exchange devices, according to disclosed embodiments. FIG. 10 illustrates a cross section view, while FIG. 11 illustrates an exploded view.

In these embodiments, spacer plates 1102 are rotated according to rotation of torque limiter shaft 808, due to splines 1001b. On the other hand, torque exchange devices 908 are rotated according to rotation of motor shaft 604 due to splines 1001c. A lower surface of the upper spacer plate 1102 can be a frictionally limited interface based on contact with an upper surface (e.g., friction material) of the upper torque limiter device 908. Similarly, a lower surface of the lower spacer plate 1102 can be a frictionally limited interface based on contact with an upper surface of the lower torque limiter device 908, resulting in two interface regions where slippage can occur by operation of torque limiting techniques disclosed herein.

In some embodiments, both sides (e.g., upper and lower) of the lower spacer plate 1102 can be in contact with friction surfaces of each of the upper and lower torque exchange device 908, resulting in three interfaces where slippage can occur by operation of torque limiting techniques detailed herein.

FIGS. 12 and 13 illustrate further additional embodiments. FIG. 12 illustrates a cross section view of apparatus 1300 with a single shaft design in which the output hub 906 is coupled to a blade assembly 1320, according to disclosed embodiments. As illustrated, a motor assembly 1330 is coupled to a torque limiter assembly 1310 contained at least partially within a housing of motor assembly 1330. Torque limiter assembly 1310 is coupled to blade assembly 1320. In this example, there is not a separate torque limiter shaft (e.g., torque limiter shaft 808). Thus, bolt 903 couples to motor shaft 604, which is distinct from other embodiments, in which bolt 903 is instead secured to torque limiter shaft 808.

Input hub 904 is rotationally coupled to motor shaft 604. Output hub 906 is rotationally coupled to blade assembly 1320. Situated in between is torque exchange device 908, which operates as detailed herein. In this example, mechanical spring force device 1002 applies a force (e.g., continuous force 1004) in a downward direction according to the depicted orientation. This force is applied direction to input hub 904 and is subsequently contained by bolt 903.

FIG. 13 illustrates a cross section view of apparatus 1400 in which spring forces are not self-contained, according to disclosed embodiments. In this example, mechanical spring force device 1002 applies a spring force (e.g., continuous force 1004) to output hub 906. An opposing force (e.g., opposing force 1005) can be applied to bearing device 910, as here, or, in other embodiments, to a shoulder or ledge (e.g., ledge 1006, as illustrated in FIG. 6).

In this example, the spring force is generated by multiple instances of mechanical spring force device 1002, which is transferred through torque exchange device 908 to input hub 904. Via shoulder 1402, input hub 904 transfers the spring force to motor shaft 604, where it is then transferred to motor bearings 606.

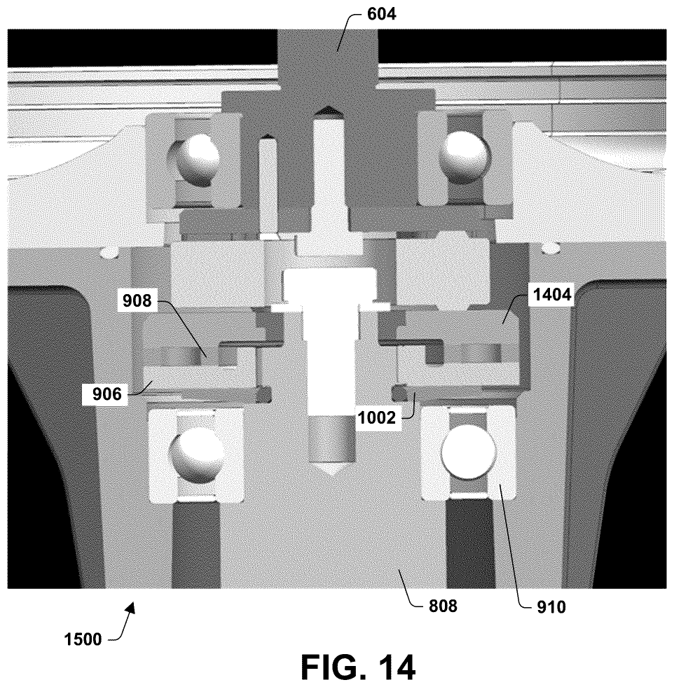

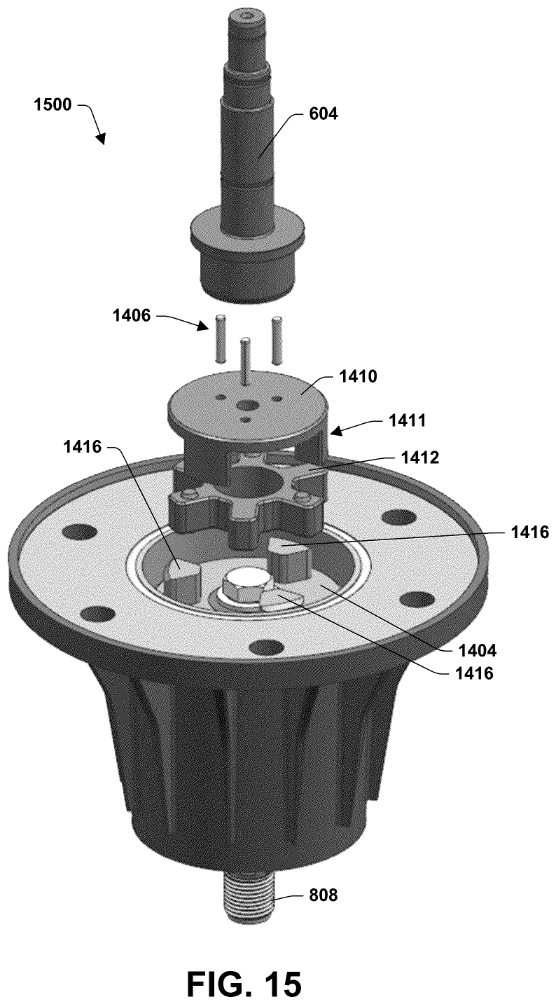

Turning now to FIG. 14 and FIG. 15 shown are a cross sectional view of an example torque limiter assembly 1500 and an exploded view thereof showing additional aspects or detail, according to disclosed embodiments. As illustrated, motor shaft 604 is coupled, via transmission elements 1410, 1412, and 1416 to input hub 1404 such that torque is readily transferred therebetween. Likewise, torque limiter shaft 808 is coupled, via separate spline interfaces, such as those described above, to output hub 906 such that torque is readily transferred therebetween. Situated between, and in contact with, input hub 1404 and output hub 906 is torque exchange device 908, comprising a friction material as described herein.

Similar to that described above, torque exchange device 908 can operate to transfer torque forces between motor shaft 604 and torque limiter shaft 808 up to a defined magnitude, beyond which friction slippage will occur. Such friction slippage can over time cause wearing or thinning of torque exchange device 908 and/or the associated friction material. As noted, while one contact interface of torque exchange device 908 can be bonded (e.g., to either input hub 1404 or output hub 906), in order to ensure that suitable contact at the other contact interface is maintained, even in the face of wear or thinning, torque limiter assembly 1500 can comprise a mechanical spring force device 1002. Mechanical spring force device 1002 can be configured to apply a continuous force, either directly or indirectly, to torque exchange device 908. This continuous force can be configured to be sufficient to maintain sufficient contact between the friction material and an associated coupler (e.g., either or both of input hub 1404 and output hub 906) to maintain a coefficient of static friction at a selected value or range of values. Additionally, mechanical spring force device 1002 can maintain continuous force in view of potential wear to the friction material, thermal expansion, thermal contraction, or other forces or phenomena that might affect friction material contact and/or friction coefficients.

With further reference to FIGS. 14 and 15, example torque limiter assembly 1500 shows transmission elements 1410, 1412, and 1416 that are adapted to transmit torque between motor shaft 604 and input hub 1404. In the non-limiting embodiment shown, a first transmission element is a first lug plate 1410 operationally engaged with motor shaft 604. The first lug plate provides a first set of lugs 1411 that are adapted for engagement with a corresponding second set of lugs 1416. The first set of lugs 1411 and the second set of lugs are shown to be engaged through an optional adapter 1412. Adapter 1412 may be substantially rigid or may be elastomeric in nature. The second set of lugs 1416 are shown to be integrally formed with input hub 1404, but this is not limiting and other forms are contemplated where the second set of lugs 1416 are engaged directly or indirectly to the input hub by mechanical fasteners, adhesives, welding, or otherwise as chosen with good engineering judgement. In the embodiment shown in FIG. 15, first lug plate 1410 is operationally engaged with motor shaft 604 with a set of mechanical fasteners 1406 but this is not limiting and other forms are contemplated where the first lug plate 1410 is integrally formed with the motor shaft 604 or is engaged directly or indirectly to the motor shaft 604 by adhesives, welding or otherwise as chosen by good engineering judgement. In FIG. 15, the first set of lugs 1411 and the second set lugs 1416 are each shown to be a set of three lugs equally spaced about a central axis, but this is not limiting and other forms of lugs are contemplated as long as they are adapted to interconnect to transmit the operable levels of torque either directly or through adapter 1412, including lug sets that each comprise 2, 4, 5, 6, 7, 8, 9, 10 or more lugs, and arrangements that are irregularly spaced about the central axis.

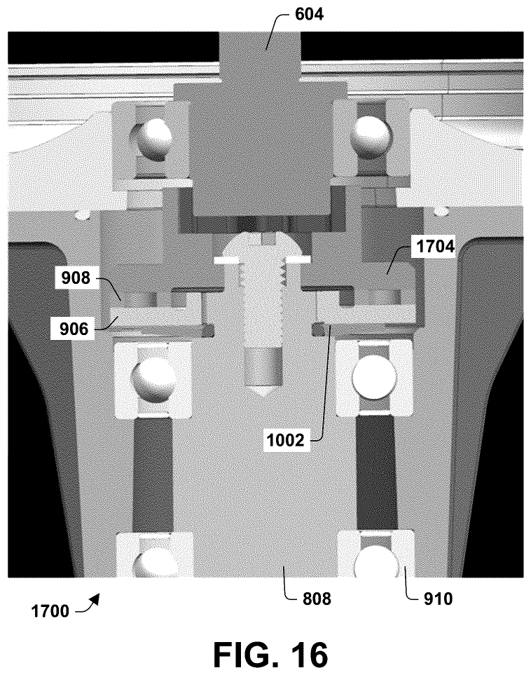

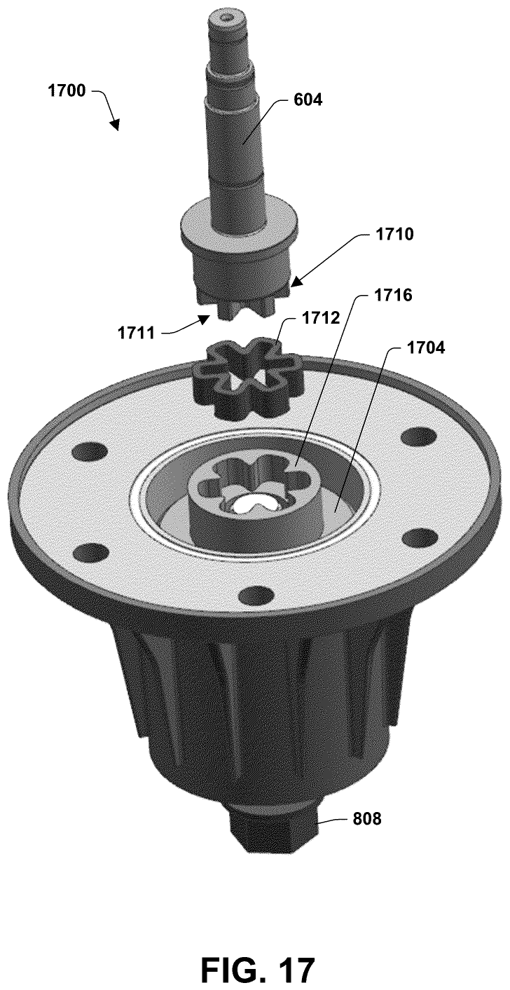

Turning now to FIG. 16 and FIG. 17, shown are a cross sectional view of an example torque limiter assembly 1700 and an exploded view thereof showing additional aspects or detail, according to disclosed embodiments. As illustrated, motor shaft 604 is coupled, via transmission elements 1710, 1712, and 1716 to input hub 1704 such that torque is readily transferred therebetween. Likewise, torque limiter shaft 808 is coupled, via separate spline interfaces, such as those described above, to output hub 906 such that torque is readily transferred therebetween. Situated between, and in contact with, input hub 1704 and output hub 906 is torque exchange device 908, comprising a friction material as described herein.

Similar to that described above, torque exchange device 908 can operate to transfer torque forces between motor shaft 604 and torque limiter shaft 808 up to a defined magnitude, beyond which friction slippage will occur. Such friction slippage can over time cause wearing or thinning of torque exchange device 908 and/or the associated friction material. As noted, while one contact interface of torque exchange device 908 can be bonded (e.g., to either input hub 1704 or output hub 906), in order to ensure that suitable contact at the other contact interface is maintained, even in the face of wear or thinning, torque limiter assembly 1700 can comprise a mechanical spring force device 1002. Mechanical spring force device 1002 can be configured to apply a continuous force, either directly or indirectly, to torque exchange device 908. This continuous force can be configured to be sufficient to maintain sufficient contact between the friction material and an associated coupler (e.g., either or both of input hub 1704 and output hub 906) to maintain a coefficient of static friction at a selected value or range of values. Additionally, mechanical spring force device 1002 can maintain continuous force in view of potential wear to the friction material, thermal expansion, thermal contraction, or other forces or phenomena that might affect friction material contact and/or friction coefficients.

With further reference to FIGS. 16 and 17, example torque limiter assembly 1700 shows transmission elements 1710, 1712, and 1716 that are adapted to transmit torque between motor shaft 604 and input hub 1704. In the non-limiting embodiment shown, a first transmission element is a first star-shaped or first stelliform feature 1710 operationally engaged with motor shaft 604. The first stelliform feature 1710 provides a first set of protrusions 1711 that are adapted for engagement with a corresponding second stelliform feature 1716. By way of illustration of the first stelliform feature 1710 and the first set of protrusions 1711, in the non-limiting embodiment shown, first stelliform feature 1710 is asterisk-shaped (*) having six protrusions each radiating outwardly from the center of the shape. The first set of protrusions 1711 and the second stelliform feature 1716 are shown to be engaged through an optional adapter 1712. Adapter 1412 may be substantially rigid or may be elastomeric in nature. The second stelliform feature 1716 is shown to be integrally formed with input hub 1704, but this is not limiting and other forms are contemplated where the second stelliform feature 1716 is engaged directly or indirectly to the input hub 1704 by mechanical fasteners, adhesives, welding, or otherwise as chosen with good engineering judgment. In the embodiment shown in FIG. 17, the first stelliform feature 1710 is integrally formed with motor shaft 604 but this is not limiting and other forms are contemplated where the first stelliform feature 1710 is engaged directly or indirectly to the motor shaft 604 by mechanical fasteners, adhesives, welding, or otherwise as chosen with good engineering judgment.

In FIG. 17, the first stelliform feature 1710 and the second stelliform feature 1716 are each shown to be star-shaped with a set of six protrusions radiating from a center and equally radially from one another, but this is not limiting and other forms of stelliform features are contemplated as long as they are adapted to interconnect to transmit the operable levels of torque either directly or through adapter 1712, including star-shapes that each comprise 2, 3, 4, 5, 7, 8, 9, 10 or more protrusions, and arrangements that are irregularly spaced about the center. Also, in the non-limiting embodiment of FIG. 17, the first stelliform feature 1710 is male and the second stelliform feature 1716 is female in the sense that the first stelliform feature 1710 is received within the second stelliform feature 1716 during operational engagement. It is contemplated that this arrangement may readily be reversed in an aspect wherein the first stelliform feature 1710 is female and the second stelliform feature 1716 is male.

Generally, the illustrated embodiments are not provided as strict limitations on how the disclosed aspects can be practiced by one of ordinary skill in the art but are intended to be provided as examples that can be modified, interchanged, added to or subtracted from as would be suitable to one of ordinary skill in the art to accomplish the purposes and objectives described herein. As an example, an arrangement of components depicted in one embodiment can be swapped with components depicted in another embodiment, optionally excluding some components, or including other components illustrated in a third embodiment, according to design creativity of one of ordinary skill in the art. For instance, bearing device 910 can be implemented in conjunction with example torque limiter assembly 1000, 1100 or 1200 of FIG. 6, 8 or 10, as suitable. Likewise, any of torque limiter assemblies 1000, 1100, 1200 can be substituted for torque limiter assembly 800 within FIG. 4, physically and operably coupled with example motor assembly of FIG. 2, and so forth. As a further example, components of disclosed devices can be implemented as connected to other components rather than included within the parent device. For instance, mechanical spring force device 1002 can be physically integrated with output hub 906, as one example among many. Alternatively, the opposite orientation can be implemented within the scope of the disclosure: one component (e.g., first blade 702a) depicted separate from another component (e.g., second blade 702b) can be aggregated as a single component in some embodiments (e.g., integrated to embody four cutting edges with a single structure). Additionally, it is noted that one or more disclosed processes can be combined into a single process providing aggregate functionality. Still further, components of disclosed machines/devices/structures/assemblies can also interact with one or more other components not specifically described herein but known by those of skill in the art.

In regard to the various functions performed by the above described components, machines, devices, processes and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the embodiments. In this regard, it will also be recognized that the embodiments include a system as well as electronic hardware configured to implement the functions, or a computer-readable medium having computer-executable instructions for performing the acts or events of the various processes.

As utilized herein, relative terms and terms of degree including the term “about”, “approximately”, “substantially”, “roughly”, “near” and others are intended to incorporate ranges and variations about a qualified term reasonably encountered by one of ordinary skill in the art in fabricating, compiling or optimizing the embodiments disclosed herein to suit design preferences, where not explicitly specified otherwise. When utilized to modify a numerical description of a disclosed element, a relative term can imply a suitable range about the given number. Any implied range is intended to be consistent with and achieve the same or similar functions as described for the disclosed structure given the numerical description, where applicable. Where such ranges are not explicitly disclosed, a range within typical manufacturing tolerances associated with suitable manufacturing equipment (e.g., injection molding equipment, extrusion equipment, metal stamping equipment, and so forth) understood by one of ordinary skill in the art for realizing an element from a disclosed illustration or description can be implied. In some embodiments, depending on context and the capabilities of one of ordinary skill in the art, relative terminology can refer to a variation in a disclosed value or characteristic; e.g., a zero to two or three-percent variance, a zero to five-percent variance or a zero to ten-percent variance from precise mathematically defined value or characteristic, or any suitable value or range there between can define a scope for a disclosed term of degree. As an example, a disclosed mechanical dimension can have a variance of suitable manufacturing tolerances as would be understood by one of ordinary skill in the art, or a variance of a few percent about the disclosed mechanical dimension that would achieve a stated purpose or function of the disclosed mechanical dimension. Relative terms utilized for qualitative (rather than quantitative) description can be understood to imply explicitly stated alternatives or variations, variations understood in the art to occur from manufacturing tolerances or variations in a manufacturing process, variations understood in the art to achieve the function or purpose described for a particular component or process, or a suitable combination of the foregoing.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

As used in this application, the term “or” is intended to mean an inclusive “or” rather than an exclusive “or”, so that usage of “or” can have the same meaning as “and/or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In other embodiments, combinations or sub-combinations of the above disclosed embodiments can be advantageously made. Moreover, embodiments described in a particular drawing or group of drawings should not be limited to those illustrations. Rather, any suitable combination or subset of elements from one drawing(s) can be applied to other embodiments in other drawings where suitable to one of ordinary skill in the art to accomplish objectives disclosed herein, known in the art, or reasonably conveyed to one of ordinary skill in the art by way of the context provided in this specification. Where utilized, block diagrams of the disclosed embodiments or flow charts are grouped for ease of understanding. However, it should be understood that combinations of blocks, additions of new blocks, re-arrangement of blocks, and the like are contemplated in alternative embodiments of the present disclosure.

Based on the foregoing it should be understood that the examples and embodiments described herein are for illustrative purposes only and that various modifications or changes in light thereof will be suggested to persons skilled in the art and are to be included within the spirit and purview of this application and scope of the appended claims.

What is claimed is:

1. An electric mowing device, comprising:
a motor assembly comprising:
a motor shaft; and
an electric motor configured to rotate the motor shaft;
a blade assembly, configured to couple to the motor shaft, that, in operation, performs a mowing function; and
a modular torque limiter assembly, situated between the motor assembly and the blade assembly, the modular torque limiter assembly comprising:
a mounting plate that secures the modular torque limiter assembly to the electric motor;
a sealed housing that covers and provides structural support to internal components of the modular torque limiter assembly, the internal components comprising:
a torque limiter shaft having a first portion that is enclosed by the sealed housing and a second portion, extending outside the sealed housing, that couples to the blade assembly;
a first shaft coupler that couples to the motor shaft in a manner that transfers torque between the motor shaft and the first shaft coupler;
a second shaft coupler that couples to the first portion of the torque limiter shaft enclosed by the sealed housing in a manner that transfers torque between the torque limiter shaft and the second shaft coupler; and
a torque exchange device, comprising a friction material, that contacts the first shaft coupler and the second shaft coupler, wherein the torque exchange device is configured to, via the friction material, limit a magnitude of the torque force transferred between the motor shaft, via the first shaft coupler, and the torque limiter shaft, via the second shaft coupler.

2. The electric mowing device of claim 1, further comprising a ball bearing device configured to reduce a magnitude of an axial force, a transverse force or both an axial and transverse force, that is transferred from the torque limiter shaft to the motor shaft in a direction along or substantially along a length dimension of the torque limiter shaft and the motor shaft.

3. The electric mowing device of claim 1, wherein the blade assembly comprises multiple blades.

4. The electric mowing device of claim 3,
wherein the multiple blades comprise a first blade and a second blade that is offset from the first blade by an axial offset angle relative to an axis formed by the torque limiter shaft; and
wherein the axial offset angle is in a range of between 60 degrees and 120 degrees.

5. The electric mowing device of claim 1, wherein the friction material comprises at least one material selected from of a group consisting of: an organic friction material, a ceramic friction material, a metallic friction material, a non-metallic friction material, a suitable combination of any of the foregoing and a suitable compound of any of the foregoing.

6. The electric mowing device of claim 1, wherein the friction material is configured to limit the magnitude of a torque transferred between the motor shaft and the torque limiter shaft to be less than a defined magnitude or range of magnitudes.

7. The electric mowing device of claim 6,
wherein the friction material is selected to have a coefficient of static friction such that the defined magnitude is a function of a characteristic of the electric motor;
wherein the defined magnitude is determined to be greater than a maximum torque output by the electric motor on the motor shaft.

8. The electric mowing device of claim 1, wherein the torque exchange device comprises one or more layers of the friction material that are, respectively, separated by, and in contact with, a respective intermediate shaft coupler that is situated between the first shaft coupler and the second shaft coupler, and at least one intermediate shaft coupler couples to the torque limiter shaft in a manner that transfers the torque force between the torque limiter shaft and the one or more layers of the friction material.

9. The electric mowing device of claim 1, wherein the torque exchange device comprises:
an intermediate shaft coupler, situated between the first shaft coupler and the second shaft coupler, configured to transfer torque from the torque limiter shaft;
a first layer of the friction material that is in contact with the first shaft coupler and in contact with the intermediate shaft coupler; and
a second layer of a second friction material that is in contact with the intermediate shaft coupler and in contact with the second shaft coupler.

10. The electric mowing device of claim 1, wherein the torque exchange device comprises:
a first intermediate shaft coupler, situated between the first shaft coupler and the second shaft coupler, configured to transfer torque from the torque limiter shaft;
a second intermediate shaft coupler, situated between the first shaft coupler and the second shaft coupler and proximal to the first intermediate shaft coupler, configured to transfer torque from the torque limiter shaft;
a first layer of the friction material that is in contact with the first shaft coupler and in contact with the first intermediate shaft coupler;
a second layer of a second friction material that is in contact with the first intermediate shaft coupler and in contact with the second intermediate shaft coupler; and
a third layer of a third friction material that is in contact with the second intermediate shaft coupler and in contact with the second shaft coupler.

11. The electric mowing device of claim 1, further comprising a mechanical spring force device that applies a continuous force to the torque exchange device that is configured to maintain sufficient contact between the friction material and an associated coupler in view of wear or thermal expansion or contraction affecting the internal components of the modular torque limiter assembly.

12. The electric mowing device of claim 11,
wherein the mechanical spring force device is at least one member selected from a group consisting of: a Belleville washer, a conical disc spring, a coil compression spring and a leaf spring;
wherein the mechanical spring force device is situated in contact with the second shaft coupler;
wherein the mechanical spring force device is situated on a ledge of the torque limiter shaft; and
wherein the mechanical spring force device is in contact with, and applies the continuous force directly to, the second shaft coupler or a spacer plate, with an opposing force being applied to the ledge of the torque limiter shaft.

13. A mowing device, comprising:
a motor assembly comprising:
a motor shaft; and
a motor configured to rotate the motor shaft;
a blade assembly that, in operation, performs a mowing function; and
a torque limiter assembly, situated between and coupled to the motor assembly and the blade assembly, the torque limiter assembly comprising:
a torque limiter shaft that is aligned with the motor shaft;
an input hub that couples to the motor shaft in a manner that transfers torque between the motor shaft and the input hub;
an output hub that couples to the torque limiter shaft in a manner that transfers torque between the torque limiter shaft and the output hub; and
a torque exchange device that contacts the input hub and the output hub and is configured to facilitate friction slipping between the torque exchange device and at least one of:
the input hub or the output hub, to limit a magnitude of torque transferred between the motor shaft and the torque limiter shaft to a maximum torque value.

14. The mowing device of claim 13, further comprising mechanical spring force device that applies a continuous force to the output hub.

15. The mowing device of claim 14, wherein the mechanical spring force is transferred through the motor shaft and opposed by motor bearings situated in the motor assembly.

16. A mowing device, comprising:
a motor assembly having
a motor shaft; and
a motor configured to rotate the shaft;
a blade assembly operationally engaged to the motor shaft such that it is adapted to perform a mowing function; and
a torque limiter assembly operationally engaged with the motor assembly and the blade assembly to selectably transmit torque therebetween, the torque limiter assembly having
an input hub operationally engaged with the motor shaft in a manner that transfers torque between the motor shaft and the input hub,
an output hub operationally engaged with the blade assembly in a manner that transfers torque between the blade assembly and the output hub, and
a torque exchange device
engaged with the input hub and the output hub,
wherein the engagement with either the input hub or the output hub is adapted to selectably slip in order to
transfer torque less than a target magnitude between the input hub and the output hub, and
prevent the transfer of torque not less than a target magnitude between the input hub and the output hub.

17. The mowing device of claim 16, wherein the torque exchange device facilitates friction slipping between the torque exchange device and at least one of the input hub, or the output hub.

18. The mowing device of claim 16, wherein the torque limiter assembly is of modular design adapted to readily be operationally disengaged from the motor assembly.

19. The mowing device of claim 16, wherein the torque limiter assembly further comprises a housing selectably sealed to
protect the input hub, output hub, and torque exchange device from contaminants, or to secure the input hub, output hub, and torque exchange device from unauthorized interference.

20. The mowing device of claim 16,
wherein the torque exchange device facilitates friction slipping between the torque exchange device and at least one of the input hub, or the output hub;
wherein the torque limiter assembly is of modular design adapted to readily be operationally disengaged from the motor assembly; and
wherein the torque limiter assembly further comprises a housing selectably sealed to
protect the input hub, output hub, and torque exchange device from contaminants, or
to secure the input hub, output hub, and torque exchange device from unauthorized interference.
